(19) United States
(12) Patent Application Publication
(10) Pub. No.: US 2016/0261653 A1
(43) Pub. Date: Sep. 8, 2016

(54) METHOD AND COMPUTER PROGRAM FOR PROVIDING CONFERENCE SERVICES AMONG TERMINALS

(71) Applicant: LINE CORPORATION, Tokyo (JP)

(72) Inventor: Yeon Jeong KIM, Seongnam-si (KR)

(21) Appl. No.: 14/824,700

(22) Filed: Aug. 12, 2015

(30) Foreign Application Priority Data
Mar. 6, 2015 (KR) 10-2015-0031433

(51) Int. Cl. H04L 29/06; H04L 29/08; H04L 12/761

(52) U.S. Cl. CPC H04L 65/403; H04L 45/16; H04L 67/06; H04L 67/306; H04L 65/1069

(57) ABSTRACT

In one example embodiment, a method of providing a conference service includes receiving, by a processor, a request from a first terminal for creating a conference with a second terminal and a third terminal as members of the conference, and in response to the request for creating the conference, creating, by the processor, the conference that has the first to third terminals as members. The method further includes receiving, by the processor, a voice file including one or more pieces of sound data with a volume equal to or greater than a threshold volume, and information on an at least one attending member, from at least one of the first terminal, the second terminal and the third terminal, the at least one attending member being from among the first terminal, the second terminal and the third terminal, generating, by the processor, conference data by merging the received voice file and the information on the at least one attending member; and providing, by the processor, the conference data to the first terminal, the second terminal and the third terminal. The attending member is a member of the conference room who owns a terminal via which sound is input with a volume equal to or greater than the threshold volume.

### CROSS-REFERENCE TO RELATED APPLICATION

This application claims the benefit of Korean Patent Application No. 10-2015-0031433, filed on Mar. 6, 2015, in the Korean Intellectual Property Office, the disclosure of which is incorporated herein in its entirety by reference.

### BACKGROUND

1. Field

The present disclosure relates to a method of providing a conference service and/or a computer program product, and more particularly, to a method of providing a conference service and/or a computer program product that provides a conference room, in which a plurality of users geographically apart from each other may participate in a remote conference.

2. Description of the Related Art

Recent development in communication technology provides various services to users, and attention on a multipoint conference service by which people who are geographically apart from each other may have a conference has been raised due to the spread of the Internet and active use of multimedia content.

The multipoint conference service connects a plurality of terminals by using a communication link, and provides a service by transmitting image data or voice data of members attending a conference via the connected communication link. In general, when users who are in different locations from each other want to have a conference, each user provides information including voice, video, data, or the like as a multipoint conference unit (MCU), and then the MCU integrates transmitted information of the users. The integrated information is multicast again to each of the users. The MCU is generally configured as a multipoint controller (MC) for controlling a center of a multipoint conference and a multimedia processor (MP) for merging a multipoint audio and a video stream into a single stream to multicast.

### SUMMARY

Provided are a method of providing a conference service and/or a computer program product that provides a conference room, in which a plurality of users who are geographically apart from each other may have a remote conference.

Additional aspects will be set forth in part in the description which follows and, in part, will be apparent from the description, or may be learned by practice of example embodiments.

In one example embodiment, a method of providing a conference service includes receiving, by a processor, a request from a first terminal for creating a conference with a second terminal and a third terminal as members of the conference, and in response to the request for creating the conference, creating, by the processor, the conference that has the first to third terminals as members. The method further includes receiving, by the processor, a voice file including one or more pieces of sound data with a volume equal to or greater than a threshold volume, and information on an at least one attending member, from at least one of the first terminal, the second terminal and the third terminal, the at least one attending member being from among the first terminal, the second terminal and the third terminal, generating, by the processor, conference data by merging the received voice file and the information on the at least one attending member; and providing, by the processor, the conference data to the first terminal, the second terminal and the third terminal. The attending member is a member of the conference room who owns a terminal via which sound is input with a volume equal to or greater than the threshold volume.

In yet another example embodiment, the creating the conference includes, in response to the request for creating the conference room, generating a conference status screen of the conference, providing the conference status screen to the first terminal, receiving a final request for creating a conference room that has second and third terminals as members, from the first terminal and in response to the final request for creating the conference, creating the conference that has the first to third terminals as the members. The conference status screen displays the status of the conference, and includes information on the members included in the conference or information on the members attending the conference.

In yet another example embodiment, the conference data comprises at least one of data selected from information on at least one the attending member included in a conference process screen of the conference, profile photos of the members, status information on the members, time information on when each of the members attends and leave the conference, the total number of members in the conference, duration time of the conference, and status information on the conference.

In yet another example embodiment, the creating the conference includes transmitting an invitation message including a link to the conference, to the second terminal and the third terminal, and in response to an event for selecting the link, allowing at least one of the second and third terminals to attend the conference. The status of the attending member in the conference is set as attending.

In yet another example embodiment, the creating the conference includes transmitting an invitation message including a link to the conference, to the second terminal and the third terminal, in response to an input, from at least one of the second terminal and third terminal for selecting the link, moving at least one of the second terminal and third terminal to a conference status screen of the conference, receiving an input for attending the conference on the conference status screen, from at least one of the second terminal and the third terminal and in response to the input for attending the conference, allowing the at least one of the second terminal and third terminal to attend the conference. The conference status screen displays the status of the conference, and includes information on the members included in the conference or information on the members attending the conference, and the status of the attending terminal in the conference is set as attending.

In yet another example embodiment, the conference data includes at least one of, a representative image, the representative image being divided into regions corresponding to a number of the members included the conference, and profile photos of the members included in the conference.

In yet another example embodiment, a non-transitory computer-readable recording medium storing computer-readable instructions, which when executed by a processor, causes the processor to perform a method of providing a conference service that includes receiving, by a processor, a request from a first terminal for creating a conference with a second terminal and a third terminal as members of the conference, and in response to the request for creating the conference, creating, by the processor, the conference that has the first to third terminals as members. The method further includes receiving, by the processor, a voice file including one or more pieces of sound data with a volume equal to or greater than a threshold volume, and information on an at least one attending member, from at least one of the first terminal, the second terminal and the third terminal, the at least one attending member being from among the first terminal, the second terminal and the third terminal, generating, by the processor, conference data by merging the received voice file and the information on the at least one attending member; and providing, by the processor, the conference data to the first terminal, the second terminal and the third terminal.

In one example embodiment, a method of providing a conference service includes receiving, at a processor, a request from a first terminal for creating a first conference having a second terminal and a third terminal as members, creating, by the processor, the first conference in response to the first request, and receiving, by the processor, at least one of, a first voice file including sound data with a volume equal to or greater than a threshold volume from the first terminal when the first conference is activated, a second voice file that includes one or more sound data with a corresponding volume equal to or greater than the threshold volume and information on an attending member from at least one of the second terminal and the third terminal. The method further includes outputting, by the processor, the second voice file, displaying, by the processor, a first conference process screen by setting at least one or more of the members as attending members based on the information on the attending member; and transmitting, by the processor, the first voice file to the second terminal and the third terminal. The status of the first conference is determined upon a request from one of the first terminal, the second terminal and the third terminal, and the attending member is one of the first terminal, the second terminal and the third terminal via which sound is input with a volume equal to or greater than the threshold volume. The attending member is a member of the conference room who owns a terminal via which sound is input with a volume equal to or greater than the threshold volume.

In yet another example embodiment, the second voice file includes at least one of, first sound data received from the second terminal and having a volume equal to or greater than the threshold volume, and second sound data received from the third terminal and having a volume equal to or greater than the threshold volume.

In yet another example embodiment, the method further includes receiving a signal for requesting to deactivate the first conference from the first terminal, and in response to the received signal, converting the status of the first conference from active to being deactivated. When the status of the first conference is deactivated, the first conference process screen is not updated and does not transmit input sound to the second terminal and the third terminal.

In yet another example embodiment, the method further includes receiving, by the processor, a request from the first terminal for creating a second conference having a fourth terminal and a fifth terminal as members, and in response to the request for creating the second conference, creating, by the processor, the second conference.

In yet another example embodiment, the method further includes receiving, by using a communication unit, an invitation message for a third conference from a terminal creating the third conference room, in response to the invitation message for the third conference, accessing the third conference, receiving a conference status screen of the second conference and displaying the conference status screen of the second conference in order to identify information on members included in the third conference and information on attending members, receiving an input of a signal for attending the third conference, and in response to the signal for attending the third conference, attending the third conference.

In yet another example embodiment, a non-transitory computer-readable recording storing computer-readable instructions, which when executed by a processor, cause the processor to perform a method of providing a conference service that includes receiving, at a processor, a request from a first terminal for creating a first conference having a second terminal and a third terminal as members, creating, by the processor, the first conference in response to the first request, and receiving, by the processor, at least one of, a first voice file including sound data with a volume equal to or greater than a threshold volume from the first terminal when the first conference is activated, a second voice file that includes one or more sound data with a corresponding volume equal to or greater than the threshold volume and information on an attending member from at least one of the second terminal and the third terminal. The method further includes outputting, by the processor, the second voice file, displaying, by the processor, a first conference process screen by setting at least one or more of the members as attending members based on the information on the attending member; and transmitting, by the processor, the first voice file to the second terminal and the third terminal. The status of the first conference is determined upon a request from one of the first terminal, the second terminal and the third terminal, and the attending member is one of the first terminal, the second terminal and the third terminal via which sound is input with a volume equal to or greater than the threshold volume.

In one example embodiment, a conference service providing server includes a memory having computer-readable instructions stored therein, and a processor. The processor is configured to execute the computer-readable instructions to, receive a request from a first terminal for creating a conference having a second terminal and a third terminal as members, creating the conference having the first terminal, the second terminal and the third terminal as the members in response to the received request, receive a voice file that includes one or more sound data with a volume equal to or greater than a threshold volume and received from at least one attending member, the at least one attending member being from among the first terminal, the second terminal and the third terminal, and information on the attending member. The processor is further configured to execute the computer-readable instructions to generate conference data by merging the received voice file and the information on the at least one attending member, and provide the conference data to the terminals of the members.

In yet another example embodiment, in response to the request for creating the conference, the processor is configured to generate a conference status screen of the conference to provide the conference status screen to the first terminal, receive a final request from the first terminal for creating the conference room having the second terminal and the third terminal as members, create the conference room having the first terminal, the second terminal and the third terminal as members in response to the final request, and display the status of the conference and includes information on the members included in the conference or information on the members attending the conference.

In yet another example embodiment, the conference data includes at least one of, information on attending members included in a conference process screen of the conference, profile photos of the members, status information on the members, time information on when the members attend and leave the conference, the total number of members of the conference, time duration of the conference, and status information of the conference.

In yet another example embodiment, the processor is configured to transmit to the second terminal and the third terminal an invitation message including a link to the conference, and in response to an event for selecting the link, allow at least one of the second terminal and third terminal to attend the conference. The status of the at least one of the second terminal and the third terminal attending the conference is set as attending.

In yet another example embodiment, the processor is configured to transmit to the second terminal and the third terminal an invitation message including a link to the conference, in response to an input, received from at least one of the second terminal and the third terminal, for selecting the link, move at least one of the second terminal and the third terminal to a conference status screen of the conference, receive from the at least one of the second terminal and the third terminal, an input on the conference status screen, for attending the conference, in response to the input on the conference status screen, allow at least one of the second terminal and third terminal to attend the conference, display the status of the conference including information on the members included in the conference or information on the members attending the conference, and set the status of the members attending the conference to attending.

In yet another example embodiment, the conference data includes a representative image, the representative image being divided into regions of the number of members included in the conference room, and profile photos of a plurality of the members included in the conference.

### BRIEF DESCRIPTION OF THE DRAWINGS

These and/or other aspects will become apparent and more readily appreciated from the following description of the example embodiments, taken in conjunction with the accompanying drawings in which:

FIG. 1 illustrates a view showing a conference service providing system according to an example embodiment;

FIG. 2 illustrates a block diagram showing a conference service providing server according to an example embodiment;

FIG. 3 illustrates a detailed view showing a configuration of a controller;

FIG. 4 illustrates a flowchart showing a method of providing a conference service, according to an example embodiment;

FIG. 5 illustrates a view or a conference service providing device, according to an example embodiment;

FIG. 6 illustrates a view showing a configuration of a controller, according to an example embodiment;

FIG. 7 illustrates a flowchart showing a method of providing a conference service, according to an example embodiment;

FIGS. 8 and 9 illustrate flowcharts showing a method of providing a conference service, according to example embodiments;

FIG. 10 illustrates a conference list screen provided by a conference service providing device and a server, according to an example embodiment;

FIG. 11 illustrates a conference process screen provided by a conference service providing device and a server, according to an example embodiment;

FIGS. 12A-B illustrates screens of re-transmitting an invitation message for a conference, provided by a conference service providing device and a server, according to an example embodiment; and

FIGS. 13A-D illustrates screens of a removal request, provided by a conference service providing device, according town example embodiment.

### DETAILED DESCRIPTION OF EXAMPLE EMBODIMENTS

Reference will now be made in detail to example embodiments, which are illustrated in the accompanying drawings, wherein like reference numerals refer to like elements throughout. In this regard, the present example embodiments may have different forms and should not be construed as being limited to the descriptions set forth herein. Accordingly, the example embodiments are merely described below, by referring to the figures, to explain aspects. Expressions such as “at least one of,” when preceding a list of elements, modify the entire list of elements and do not modify the individual elements of the list.

Hereinafter, inventive concepts will be described in detail by explaining example embodiments of inventive concepts with reference to the attached drawings. Like reference numerals in the drawings denote like elements.

While such terms as “first,” “second,” etc., may be used to describe various elements, components, regions and/or sections, these elements, components, regions and/or sections should not be limited by these terms. These terms are only used to distinguish one element, component, region or section from another region, layer or section. Thus, a first element, component, region or section discussed below could be termed a second element, component, region or section without departing from the teachings of inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of inventive concepts. As used herein, the singular forms “a”, “an” and “the” are intended to include the plural forms as well, unless the context clearly indicates otherwise. It will be further understood that the terms “comprises” and/or “comprising” used herein specify the presence of stated features, integers, steps, operations, members, components, and/or groups thereof, but do not preclude the presence or addition of one or more other features, integers, steps, operations, members, components, and/or groups thereof.

As used herein, the term “and/or” includes any and all combinations of one or more of the associated listed items. Also, the term “exemplary”, if and when used, is intended to refer to an example or illustration.

It will be understood that when an element is referred to as being “on”, “connected to”, “coupled to”, or “adjacent to” another element or layer, it can be directly on, connected, coupled, or adjacent to the other element, or intervening elements may be present. In contrast, when an element is referred to as being “directly on,” “directly connected to”, “directly coupled to”, or “immediately adjacent to” another element, there are no intervening elements present.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

When certain example embodiments may be implemented differently, a specific process order may be performed differently from the described order. For example, two consecutively described processes may be performed substantially at the same time or performed in an order opposite to the described order.

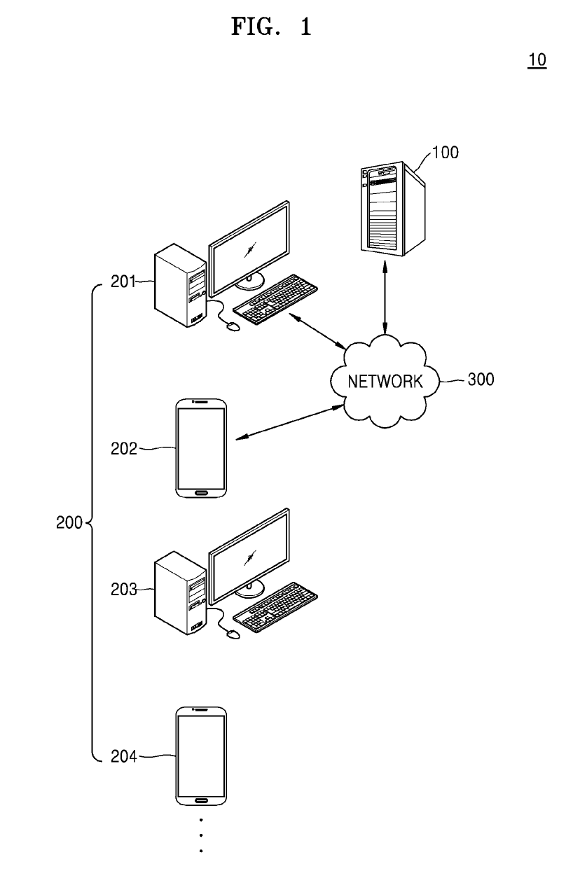

FIG. 1 illustrates a view showing a conference service providing system 10 according to an example embodiment.

Referring to FIG. 1, the conference service providing system 10 according to an example embodiment may include a conference service providing server 100, conference service providing devices 200, and a network 300.

The conference service providing server 100 may provide a conference room having a plurality of users as members of the conference room. The conference service providing server 100 may provide a representative image displaying information about members included in a conference room. The conference service providing server 100 may also display profile information and status information on members attending a conference room. For example, the conference service providing server 100 may set the status of a user, who generates sound having a volume equal to or greater than a threshold volume, from among members, as attending, and then set the status of the attending member as talking. The conference service providing server 100 may receive a removal request for removing a user from another user from among members, and then, in response to the removal request, may remove the user from a conference room. The conference service providing server 100 may transmit an invitation message including a link to the conference room, to a terminal of a third user, from among members, who did not attend the conference. The conference service providing server 100 may concurrently provide one or more conference rooms to a first user, and provide information on a closed conference room.

The conference service providing devices 200 may provide a means of providing a conference service to a user by receiving conference data from the conference service providing server 100. Alternatively, the conference service providing devices 200 may include an application for providing a conference service, and then provide, via the application, a means of providing a conference service in which a conference room has two or more members out of friends stored in a contact list. Here, the conference service providing devices 200 refers to the same device as a user terminal.

The conference service providing devices 200 refer to a communication terminal using web service through known or to be developed wired and/or wireless communication means. Here, the conference service providing devices 200 may be a personal computer of a user or a portable terminal of a user.

In detail, the conference service providing devices 200 may include, but are not limited to, a computer (e.g., a desktop, a laptop, a tablet, or the like), a media computing platform (e.g., cable, a satellite set-top box, or a digital video recorder), a handheld computing device (e.g., a personal digital assistant (PDA), an email client, or the like), any type of hand-held phone, or any type of other computing or communication platforms.

Alternatively, the network 300 may connect the conference service providing devices 200 with the conference service providing server 100. In other words, the network 300 refers to a network providing a connection path so that the conference service providing devices 200 may access the conference service providing server 100 and then transmit or receive data to or from the conference service providing server 100). The network 300 may include, for example, a wired network such as Local Area Networks (LANs), Wide Area Networks (WANs), Metropolitan Area Networks (MANs), or Integrated Service Digital Networks (ISDNs) or, a wireless network such as wireless LANs, CDMA, Bluetooth, or satellite communication, but are not limited thereto.

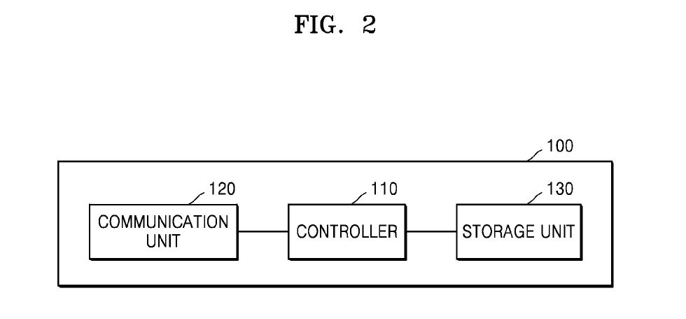

FIG. 2 illustrates a block diagram showing a conference service providing server according to an example embodiment.

Referring to FIG. 2, the conference service providing server 100 according to an example embodiment may include a controller 110, a communication unit 120, and a storage unit 130.

The controller 110 may set up a conference room, in response to a request for setting up (creating) a conference room having second and third users as members received from a terminal of a first user, and may transmit an invitation message to terminals of the members. The controller 110 may provide conference service among the first to third users via the conference room, and generate a representative image including the number of members attending the conference room, profile information thereof, or the like to provide to the members. Accordingly, the conference service providing server 100 may provide information on the members included in the conference room to be shown at a glance.

If each sound received from the terminals of the first to third users meets a predetermined (and/or alternatively, desired) condition, the controller 110 may generate a voice file by combining the sounds. The controller 110 finds the period which may be the subject of recognition from the sounds. The controller 110 removes the noise component contained in the period which may be the subject of recognition. The controller 110 may generate a voice file containing only the sounds to remove the noise component. As a result, the conference service providing server 100 may remove noise irrelevant to a conference, and thus provide only voice data related to the conference.

The controller 110 may control the conference service providing server 100 to transmit the voice file to each terminal of the members. The controller 110 may distinguish a member attending the conference room from the members and separately display the members. In this regard, when a plurality of attending members attend a conference room, the conference service providing server 100 may separately and independently display information on each of the attending members to figure out the one who actively attends a conference.

The communication unit 120 may include at least one component through which the conference service providing devices 200 may communicate with the conference service providing server 100. For example, the communication unit 120 may include a short-range communication unit and a mobile communication unit. The short-range communication unit may include, but is not limited to, a Bluetooth communication unit, a Bluetooth low energy (BLE) communication unit, a near field wireless communication unit, a WLAN (Wi-Fi) communication unit, a ZigBee communication unit, an infrared data association (IrDA) communication unit, a Wi-Fi direct (WFD) communication unit, an ultra wideband (UWB) communication unit, an Ant+ communication unit, or the like. The mobile communication unit exchanges a wireless signal with at least one of a base station, an external apparatus, and a server in a mobile communication network. Here, the wireless signal may include various types of data depending on a voice call signal, a video call signal, or a text/multimedia message transmission and reception.

Via the communication unit 120, the conference service providing server 100 may receive, from the conference service providing devices 200, not only profile information of a user but also data to be shared with the members included in the conference room such as, sound information input by a user, a photo, a link, or a video.

The storage unit 130 may store user information registered in the conference service providing server 100, information on one or more conference rooms among users, or the like.

While the conference service providing server 100 has been shown in FIG. 2 and described above as having three separate units (communication unit 120, the controller 110 and the storage unit 130), in one or more example embodiments, the conference service providing server 100 may include a memory and a processor. The memory may have computer-readable instructions stored thereon for carrying out the functionalities of the controller 110, the communication unit 120 and the storage unit 130, as described above. Furthermore, the processor may be configured to execute the computer-readable instructions stored on the memory of the conference service providing server 100 (thus transforming the processor into a special-purpose processor), in order to implement the functions of the controller 110, the communication unit 120 and the storage unit 130 as described above.

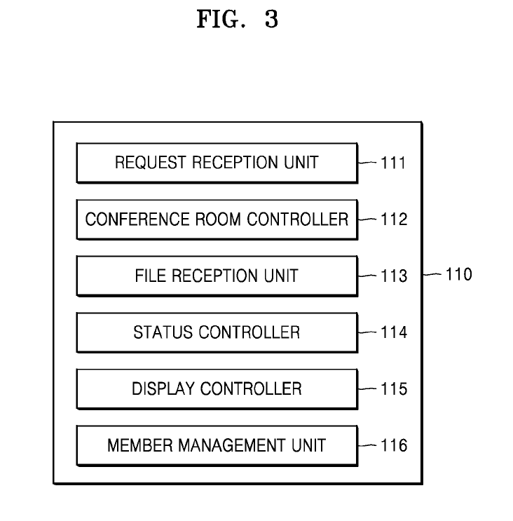

FIG. 3 illustrates a detailed view showing a configuration of the controller, according to an example embodiment.

Referring to FIG. 3, the controller 110 may include a request reception unit 111, a conference room controller 112, a file reception unit 113, a status controller 114, a member management unit 116, and a display controller 115.

The request reception unit 111 may receive a request for setting up a conference room having three or more users as members from a terminal of a first user from among the members. Here, for the sake of convenience, the members of the conference room are first to third members.

The conference room controller 112, in response to the request for setting up a conference room, may set up a conference room and generate conference data corresponding to the conference room. In this case, the conference data refers to information related to the conference room, and may be configured to include information on the members included in the conference room and information related to the conference room, for example, the number of members included in the conference room, information on when a member enters and leaves the conference room, information on when the conference starts and ends, or the like.

In addition, the conference room controller 112 may generate a representative image of the conference room. Here, the representative image may be divided into regions of the number of members included in the conference room, and each divided region may display profile information for its corresponding member. The representative image may be displayed in a polygonal shape such as a triangle or a quadrangle, or in a circular shape having no corners, but is not limited thereto. For example, a representative image of a first conference room with three members may be divided into three regions, and each region may include profile information on each of the three members, while a representative image of a second conference room with five members may be divided into five regions, and each region may include profile information on each of the five members. The conference Room controller 112 may be displayed by removing the profile information of the member to leave the conference room in the representative image.

The conference room controller 112 may merge data or files received via the file reception unit 113 to share the merged data or files with the members via the conference room, and may control the conference service providing server 100 to transmit a merged final voice file or the like to each terminal of the members. The conference room controller 112 may control to store the merged final voice file to corresponding to each the conference room.

The file reception unit 113 may receive sound data to be shared via the conference room or a voice file including the sound data from the terminals of the members. The file reception unit 113 may receive profile information of the members included in the conference room from the terminals of the members. Here, the profile information refers to information that members uploaded to show themselves, and may be configured to include at least one selected from an image, a photo, a video, a voice, and a text.

In addition, the file reception unit 113 may receive image data, video data, text data, or link data to be shared via the conference room from the terminals of the members, and the file reception unit 113 may receive various types of data, which is not limited to a file type. Here, the file reception unit 113 may determine whether a received file or data meets a predetermined (and/or alternatively, desired) condition, and then, share the received file or data via the conference room only when the predetermined (and/or alternatively, desired) condition is met. For example, only when sound data or a voice file of which the volume is equal to or greater than a predetermined (and/or alternatively, desired) threshold volume or having the linguistic meaning is received, the sound data or voice file may be shared via a conference room.

The status controller 114 may manage the status of a member included in the conference room. Here, the status of the member displays a behavior of each member in the conference room, and may be, for example, one selected from attending, left, non-attending, talking, and busy. The status controller 114 may display the status of a user as talking when a voice file input by all of some users from among the members included in the conference room is received. The status controller 114 displays the status of a non-attending user who did not attend the conference room, from among all or some of the members included in the conference room, as non-attending, and distinguishably display information on an attending user and information on a non-attending user. The status controller 114 may displays the status of a user who does not activate the conference room, from among all or some of the members included in the conference room, as busy.

The display controller 115 may generate a conference list screen and a conference process screen that are provided to a terminal of a user, and control the terminal of the user to display the conference list screen and the conference process screen. The conference list screen provides information on one or more conference rooms having a user as a member, and may be configured to include an on-going conference, a closed conference, a deleted conference, or the like. In one example embodiment, the deleted conference is not likely to take place the conference. The conference process screen shows an on-going conference room, and may be configured to include information on a member included in the conference room and information related to the conference room. For example, the conference process screen may include the number of members included in the conference room, profile information on the members, status of the members, a time when a member attends or leaves, a time when the conference starts or ends, or the like.

In one example embodiment, the request reception unit 111 may receive, from a user from among the first to third users, a signal for requesting a removal of another user. In response to the signal for requesting the removal of another user, the conference room controller 112 may remove the other user the user requested to leave from the conference room.

In one example embodiment, the request reception unit 111 may receive a request for re-transmitting an invitation message for the conference to a terminal of a non-attending user. In response to the request of re-transmitting the invitation message for the conference, the conference room controller 112 may re-transmit the invitation message for the conference to the terminal of the non-attending user.

In one example embodiment, in response to an invitation message for a conference room, the conference room controller 112 may firstly provide a conference status screen of the conference room to a terminal of an attending user. Here, the conference status screen displays the status of the conference room, and may include information on members included in the conference room or information on attending members who attend the conference.

In one example embodiment, the conference room controller 112 may receive a request from a user who wants to set up a conference room or an invitation message for a conference room and thus, receive an input of a user ID which is used to identify the user instead of the user's name and profile information from a user who wants to attend the conference room. Here, the profile information may include one of an image, a text, or a video as the profile information of a user.

While the controller 110 has been shown in FIG. 3 and described above as having separate units (the request reception unit 11, the conference room controller 112, the file reception unit 113, the status controller 114, the display controller 115 and the member management unit 116), in one or more example embodiments, the controller 110 may include a memory and a processor. The memory may have computer-readable instructions stored thereon for carrying out the functionalities of the request reception unit 11, the conference room controller 112, the file reception unit 113, the status controller 114, the display controller 115 and the member management unit 116, as described above. Furthermore, the processor may be configured to execute the computer-readable instructions stored on the memory of the controller 110 (thus transforming the processor into a special-purpose processor), in order to implement the functions of the request reception unit 11, the conference room controller 112, the file reception unit 113, the status controller 114, the display controller 115 and the member management unit 116 as described above.

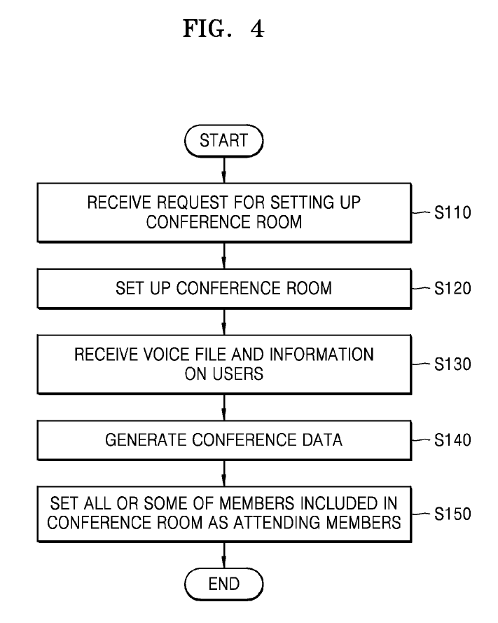

FIG. 4 illustrates a flowchart showing a method of providing a conference service, according to an example embodiment. While FIG. 4 will be described below with reference to the conference service providing server 100 and/or individual units thereof, as shown in FIGS. 2 and 3, steps of FIG. 4 may be implemented by a processor executing computer-readable instructions for carrying out the functionalities of the conference service providing server 100 and/or individual units thereof, as shown in FIGS. 2 and 3 and described above.

Referring to FIG. 4, a method of providing a conference service, according to an example embodiment, may include receiving a request for setting up a conference room (S110), setting up the conference room (S120), receiving a voice file and information on an attending user (S130), generating conference data (S140), and setting all or some members included in the conference room as an attending user (S150).

In operation S110, the conference service providing server 100 may receive a request for setting up a conference room having a plurality of users as members from a terminal of a first user.

In operation S120, in response to the request for setting up the conference room, the conference service providing server 100 may set up the conference room. In operation S120, the conference service providing server 100 may transmit an invitation message for the conference to terminals of members when the conference room is set up. The invitation message for the conference may include descriptions of the conference room, information on the members included in the conference room, a method of reaching the conference room, and a link to the conference room.

In operation S130, the conference service providing server 100 may receive not only sound data, a voice file, or the like but also profile information on each member from the terminal of the member(s) included in the conference room. Also, the conference service providing server 100 may further receive status information on the member included in the conference room. The status information is described above, and thus detailed descriptions thereof are omitted.

In operation S140, the conference service providing server 100 may generate a final voice file by mixing the received voice files, and conference data may be generated by including the final voice file, the profile information, and information on an attending member.

In operation S150, the conference service providing server 100 may set a generator of the sound data or the voice file as an attending member.

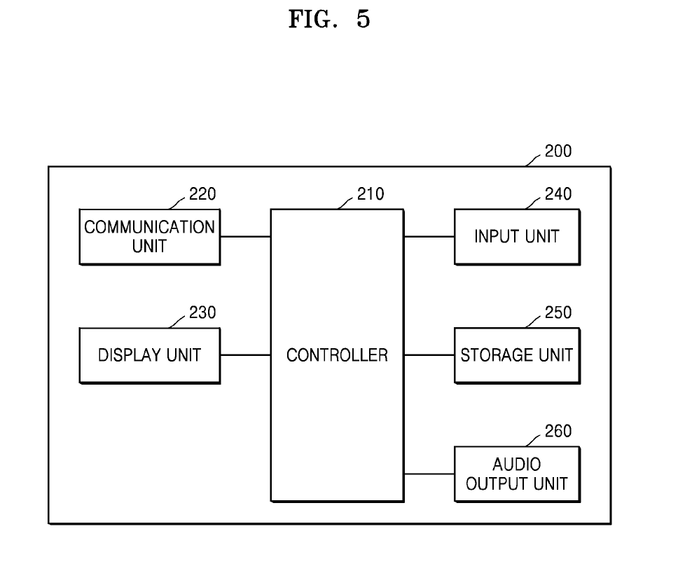

FIG. 5 illustrates a view or a conference service providing device, according to an example embodiment.

Referring to FIG. 5, a conference service providing device 200 according to an example embodiment may include a controller 210, a communication unit 220, a display unit 230, an input unit 240, a storage unit 250, and an audio output unit 260.

The controller 210 may generally control all operations of the conference service providing device 200. For example, the controller 210 may execute programs stored in the storage unit 250, and thus, control the communication unit 220, the display unit 230, the input unit 240, and the audio output unit 260.

In response to a request, received from a first user, for setting up a conference room, the controller 210 may set up the conference room and transmit an invitation message for the conference to one or more members included in the request for setting up the conference room.

The controller 210 may determine whether the volume of sound input by the first user is equal to or greater than a threshold volume, and then convert the sound having a volume equal to or greater than the threshold volume to a voice file. Accordingly, the voice file may be transmitted to a terminal of the member included in the conference room. As a result, the conference service providing devices 200 may remove noise and only share with the members voice related to the conference.

The controller 210 may receive sound data or a voice file input by the terminal of the member included in the conference room to output the sound data or a voice file. Through the received voice file, the controller 210 may distinguishably display an attending member and a non-attending member. In this regard, the conference service providing devices 200 may output a voice file shared via a conference room, and also provide information on an attending member from among members.

The controller 210, in response to a removal request input via the input unit 240, may remove a second user included in the removal request from a conference room, and, in response to a request for re-transmitting an invitation message to non-attending user, may re-transmit the invitation message for the conference room to all or some non-attending users. Also, the controller 210, in response to a leaving request input by a user, may remove the user from the conference room.

The controller 210 may receive and display information related to a member included in a conference room and information related to the conference room. In particular, the controller 210 may generate and provide a representative image for information on a member included in a conference room to be shown at a glance.

The controller 210 may differently set an input and an output depending on an activation status of a conference room. For example, when a user may set a conference room as a deactivated status, and the conference room receives sound having a volume equal to or greater than a threshold volume from the user during the deactivated period, the sound may not be shared via the conference room and a voice file from other members may not be output. Accordingly, the conference service providing device 200 may maintain a conference room of a user, and perform other operations of the user (a phone call, a reproduction of a video, or the like).

The communication unit 220 may include one or more components by which the conference service providing devices 200 may communicate with each other. For example, the communication unit 220 may include a short-range communication unit and a mobile communication unit. The short-range communication unit may include, but is not limited to, a Bluetooth communication unit, a BLE communication unit, a near field wireless communication unit, a WLAN (Wi-Fi) communication unit, a ZigBee communication unit, an IrDA communication unit, a WFD communication unit, an UWB communication unit, an Ant+ communication unit, or the like. The mobile communication unit exchanges a wireless signal with at least one of a base station, an external apparatus, and a server in a mobile communication network. Here, the wireless signal may include various types of data depending on a voice call signal, a video call signal, or a text/multimedia message transmission and reception. The communication unit 220 may communicate with the conference service providing devices 200 and the conference service providing server 100 to obtain a voice file or other files to be shared via a conference room, and data related to the conference room. The communication unit 220 may obtain an application program for a conference service and a screen displaying the conference service from the conference service providing server 100.

The display unit 230 may display a screen related to a conference service, and a user interface. The display unit 230 may display a screen depending on a user event input through the input unit 240. When the display unit 230 and a touch pad form a mutual layer structure and then are formed as a touch screen, the display unit 230 may be used as both an output device and input device. The display unit 230 may include at least one selected from a liquid crystal display, a thin film transistor-liquid crystal display, an organic light-emitting diode display, a flexible display, a 3D display, and an electrophoretic display.

The input unit 240 refers to a unit for inputting an event or data for a user to control the conference service providing device 200. For example, the input unit 240 may be, but is not limited to, a key pad, a dome switch, a touch pad (Capacitive Overlay, Resistive Overlay, Infrared Beam, Surface Acoustic Wave, Integral Strain Gauge, piezo Electric, or the like), a jog wheel, or a jog switch.

The input unit 240 may obtain, via a user interface for a conference service, a request for setting up a conference room, a request for removing some members from the conference room, a request for re-transmitting an invitation message for the conference to a terminal of a non-attending user, or the like. The input unit 240 may receive a command of activating or deactivating a conference room, and also receive a command for leaving a conference room.

The storage unit 250 may store conference data and data about members included in a conference room, obtained via the communication unit 220.

The audio output unit 260 may output a voice file obtained via the communication unit 220. Also, the audio output unit 260 may output an audio signal related to functions performed by the conference service providing devices 200. The audio output unit 260 may include a speaker, a buzzer, a vibration motor, or the like. The vibration motor may output a vibration signal. For example, the vibration motor may output a vibration signal corresponding to an output of audio data or image data. In addition, the vibration motor may output a vibration signal when a touch screen receives a touch input.

While the conference service providing device 200 has been shown in FIG. 5 and described above as having separate units (the controller 210, the communication unit 220, the display unit 230, the input unit 240, the storage unit 250, and the audio output unit 260), in one or more example embodiments, the conference service providing device 200 may include a memory and a processor. The memory may have computer-readable instructions stored thereon for carrying out the functionalities of the controller 210, the communication unit 220, the display unit 230, the input unit 240, the storage unit 250, and the audio output unit 260, as described above. Furthermore, the processor may be configured to execute the computer-readable instructions stored on the memory of the conference service providing device 200 (thus transforming the processor into a special-purpose processor), in order to implement the functions of the controller 210, the communication unit 220, the display unit 230, the input unit 240, the storage unit 250, and the audio output unit 260, as described above.

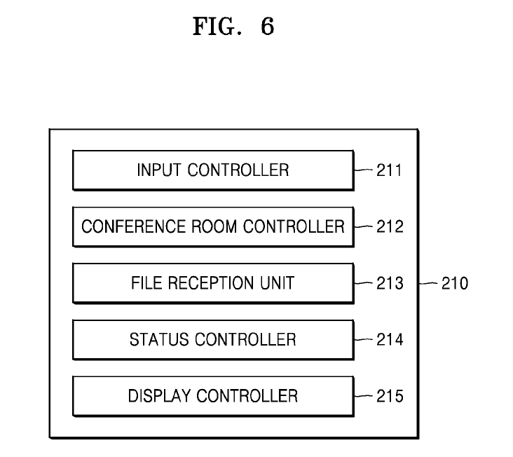

FIG. 6 illustrates a view showing a configuration of the controller 210, according to one example embodiment.

Referring to FIG. 6, the controller 210 may include an input controller 211, a conference room controller 212, a file reception unit 213, a status controller 214, and a display controller 215.

The input controller 211 may receive, from a first user, a request for setting up a conference room having second and third users as members. Also, the input controller 211 may receive, from the first user, sound or the like to be shared via the conference room. The input controller 211 may further receive, from the first user, a request for setting up a second conference room, differently from the conference room, having fourth and fifth users as members.

In response to the request for setting up the conference room, the conference room controller 212 may set up the conference room and generate conference data corresponding to the conference room. Here, the conference data refers to information related to the conference room; and may be configured to include information on the members included in the conference room, and information related to the conference room, for example, the number of members included in the conference room, information on when a member enters and leaves the conference room, information on when the conference starts and ends, or the like.

In addition, the conference room controller 212 may generate a representative image of the conference room. Here, the representative image may be divided into regions of the number of members included in the conference room, and each divided region may display profile information for its corresponding member. The representative image is described above, and thus, detailed descriptions thereof will be omitted.

The conference room controller 212 may also generate a final voice file by merging voice files received via the file reception unit 213. Here, the conference room controller 212 may determine whether the received voice files meet a predetermined condition, and based on the determination, may merge voice files that meet the predetermined condition into a final voice file. For example, the conference room controller 212 may add a voice file having a volume equal to or greater than a predetermined threshold volume to a final voice file. The conference room controller 212 may transmit the final voice file to terminals of members or control a terminal of a first user to output the final voice file.

In response to the request for setting up the second conference room, the conference room controller 212 may set up the second conference room having the fourth and fifth users as the members. The second conference room is named with the term “second” to distinguish the second conference room from the conference room and has different members from the members of the conference room, but operations of the second conference room are the same as those in the conference room, which may be, however, processed in a different manner.

The file reception unit 213 may receive sound data such as voice to be shared as a voice file, from terminals of one or more members included in the conference room. The file reception unit 213 may receive profile information on the members from the terminals of the members. The profile information is described above, and thus detailed descriptions thereof will be omitted.

In addition, the file reception unit 213 may receive image data, video data, text data, and link data to be shared via the conference room from one or more terminals of members included in the conference room, and the file reception unit 213 may receive various types of data including a file type.

The file reception unit 213 may also receive status information of each of the members. Here, the status information on each of the members refers to information including the status of each member, which displays what each member is doing in the conference room, for example, any status of attending, left, non-attending, talking, and busy.

The status controller 214 may manage the status of members included in the conference room, received via the file reception unit 213. When the status controller 114 receives a voice file input by all or some users from among the members included in the conference room, the status controller 114 may display the status of the user as talking. The status controller 214 may display the status of a user, who did not attend the conference room, from among all or some of the members included in the conference room as non-attending, and distinguishably display information on an attending user from information on a non-attending user. The status controller 214 may display the status of a user, who does not activate the conference room, from among all or some of the members included in the conference room as busy.

The conference service providing devices 200 may separately and individually manage one or more conference rooms in which a first user is included via the status controller 214. For example, both of a first conference room including second and third users and a second conference room including fourth and fifth users may be activated; any one of the first conference room and the second conference room may be activated; or both conference rooms may be deactivated. Taking into account the status of a conference room, the conference room controller 212 of the conference service providing devices 200 may transmit input sound only to an activated conference room and output only sound shared via the activated conference room. Accordingly, the conference service providing devices 200 may allow a user to concurrently process a plurality of conferences.

The display controller 215 may generate a conference list screen and a conference process screen that are provided to a terminal of a user, and control the terminal of the user to display the conference list screen and the conference process screen. Here, the conference list screen and the conference process screen are described above, and thus detailed descriptions thereof will be omitted.

In another embodiment, the input controller 211 may receive, from one of the second and third users, a signal for requesting a removal of another user. In response to the signal for requesting the removal of another user, the conference room controller 212 may remove the other user included in the signal from the conference room.

In another embodiment, the input controller 211 may receive a request for re-transmitting an invitation message for a conference to a terminal of a non-attending user. In response to the request for re-transmitting the invitation message for the conference, the conference room controller 212 may re-transmit the invitation message for the conference to a terminal of a non-attending user.

In another embodiment, the conference room controller 212 may firstly provide a conference status screen of a conference room to any one terminal of second and third users, attending the conference room, in response to an invitation message for the conference room. Here, the conference status screen displays the status of the conference room, and may include information on members included in the conference room or information on members attending the conference room.

In another embodiment, the conference room controller 212 may receive a request for setting up a conference room or an invitation message for a conference, and then receive an input of a user ID and profile information from a user who wants to attend the conference room. Here, the profile information refers to profile information on a user and may include any one selected from an image, a text, and a video.

While the controller 210 has been shown in FIG. 6 and described above as having separate units (the input controller 211, the conference room controller 212, the file reception unit 213, the status controller 214, and the display controller 215), in one or more example embodiments, the controller 210 may include a memory and a processor. The memory may have computer-readable instructions stored thereon for carrying out the functionalities of the input controller 211, the conference room controller 212, the file reception unit 213, the status controller 214, and the display controller 215, as described above. Furthermore, the processor may be configured to execute the computer-readable instructions stored on the memory of the controller. 210 (thus transforming the processor into a special-purpose processor), in order to implement the functions of the input controller 211, the conference room controller 212, the file reception unit 213, the status controller 214, and the display controller 215, as described above

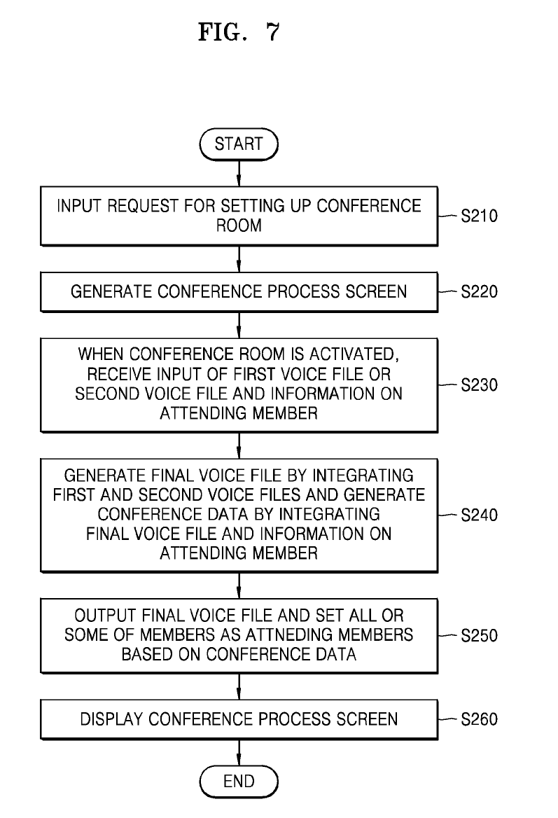

FIG. 7 illustrates a flowchart showing a method of providing a conference service, according to an example embodiment. While FIG. 7 will be described below with reference to the conference service providing server 200 and/or individual units thereof, as shown in FIGS. 5 and 6, steps of FIG. 7 may be implemented by a processor executing computer-readable instructions for carrying out the functionalities of the conference service providing server 200 and/or individual units thereof, as shown in FIGS. 5 and 6 and described above.

Referring to FIG. 7, the method of providing a conference service may include receiving a request for setting up, a conference room (S210), generating a conference process screen (S220), receiving information (S230), merging files (S240), outputting (S250), and displaying (S260).

In operation S210, the conference service providing devices 200 may receive a request for setting up a conference room having two or more users as members, from a first user.

In operation S220, the conference service providing devices 200 may set up the conference room in response to the request for setting up the conference room. In operation S220, the conference service providing devices 200 may transmit an invitation message for the conference room to terminals of the members in response to the request for setting up the conference room.

In operation S230, the conference service providing devices 200 may receive, from the first user, a first voice file having a volume equal to greater than a threshold volume when a conference room is activated, and receive, from at least one of terminals of the second and third users, a second voice file including sound having a volume equal to or greater than a threshold volume and information on an attending member. Here, the information on the attending member refers to information on a user generating the sound.

In operation S240, the conference service providing devices 200 may merge the first and second voice files to generate a final voice file. Also, the conference service providing devices 200 may merge the final voice file and the information on the attending member to generate conference data.

In operation S250, the conference service providing devices 200 may set all or some of the members as attending member(s) based on the conference data. In operation S260, the conference service providing devices 200 may generate and provide a conference process screen displaying the attending members.

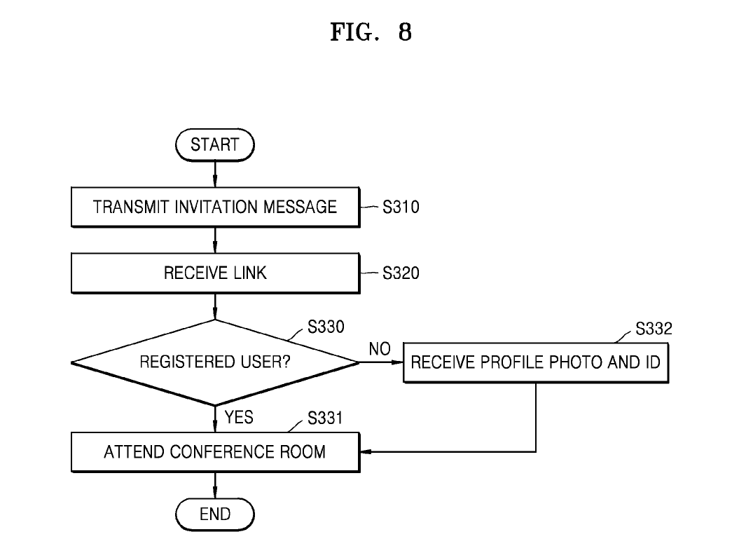

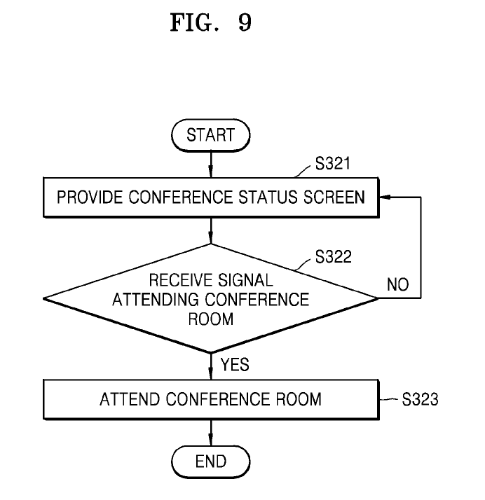

FIGS. 8 and 9 illustrate flowcharts showing methods of providing a conference service according to an example embodiment. While FIG. 8 will be described below with reference to the conference service providing server 100 and/or individual units thereof, as shown in FIGS. 2 and 3, steps of FIG. 8 may be implemented by a processor executing computer-readable instructions for carrying out the functionalities of the conference service providing server 100 and/or individual units thereof, as shown in FIGS. 2 and 3 and described above.

Referring to FIG. 8, a method of providing a conference service may include transmitting an invitation message (S310), receiving a signal for selecting a link (S320), determining whether a user is registered (S330), receiving a profile photo and an ID (S332), and allowing an attendance to the conference room (S331).

In operation S310, the conference service providing server 100 may transmit an invitation message for the conference room to a first user from among members included in the conference room. In operation S320, the conference service providing server 100 may receive a signal for selecting a link of the conference room included in the invitation message, from the first user. In operation S330, the conference service providing server 100 determines whether the first user is registered in a database (DB) provided by the conference service. If the first user is a registered user, the conference service providing server 100 may allow the first user to attend the conference room (S331). Otherwise, if the first user is not a registered user, the conference service providing server 100 may receive an input of a profile photo and an ID of the first user.

Here, the conference service may be provided by registering in a certain conference service providing server, or by using a device where an application providing a conference service is installed. However, according to the embodiment of FIG. 8, although a user does not register on a conference service providing server, the conference service providing server 100 according to an example embodiment may provide a conference service when a user inputs an ID and a profile photo of the user. The ID and the profile photo that the user input may be stored and managed by matching the ID and the profile photo, that the user input with identification information for a terminal of the user (e.g., a MAC address and an IP address, of the terminal of the user, or the like). In other words, information on a profile and an ID that a first user input may be continuously managed after using the conference service, and thus, the information may be used again when the first user sets up a conference room later or is invited to attend another conference room.

Referring to FIG. 9, operation S320 of the method of providing a conference service may include displaying a conference status screen (S321), receiving a signal for attending a conference room (S322), and attending the conference room (S323). While FIG. 9 will be described below with reference to the conference service providing server 100 and/or individual units thereof, as shown in FIGS. 2 and 3, steps of FIG. 9 may be implemented by a processor executing computer-readable instructions for carrying out the functionalities of the conference service providing server 100 and/or individual units thereof, as shown in FIGS. 2 and 3 and described above.

In operation S321, the conference service providing server 100 may provide a conference status screen displaying the status of the conference room, in response to a signal for linking to the conference room received from a terminal of a first user that received an invitation message. In operation S322, the conference service providing server 100 may determine whether a signal for attending the conference room, which is received from the terminal of the first user, has been received. When the signal for attending the conference room is received from the terminal of the first user, the conference service providing server 100 may provide a conference process screen to the terminal of the first user. Otherwise, the conference service providing server 100 may provide a conference status screen to the terminal of the first user or control the terminal of the first user to terminate the conference service.

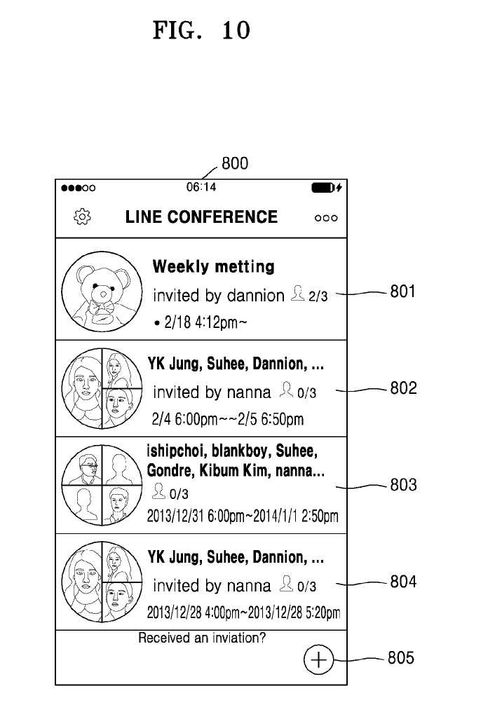

FIG. 10 illustrates of a conference list screen provided by a conference service providing device and a server, according to an example embodiment.

A conference service providing device and a server may display a conference list screen 800 including information on one or more conferences having one or more attending members). The conference list screen 800 may include information on an on-going first conference room 801, information on first, second, and third terminated conferences 802, 803, and 804, and may further include a button for adding a conference room 805. The terminated second conference 802 includes three members, and thus, an image divided into three regions may be displayed as a representative image. The terminated third conference 803 includes four members, and thus, an image divided into four regions may be displayed as a representative image. Each region may include profile information on each member.

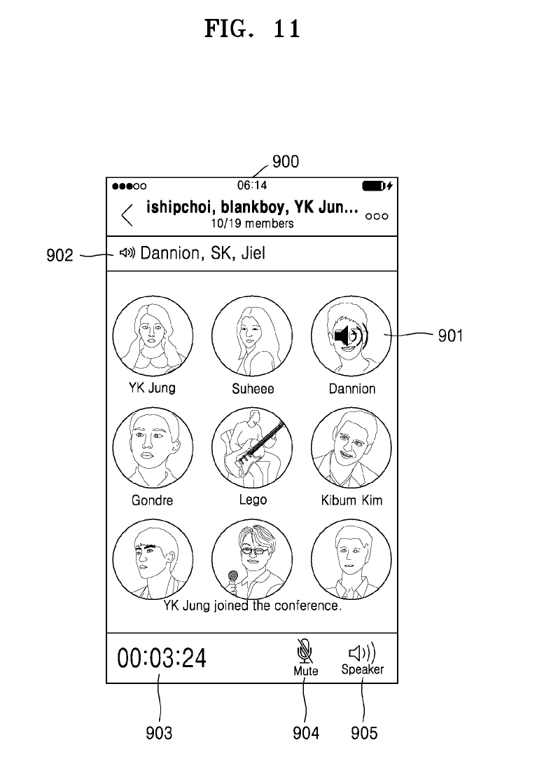

FIG. 11 illustrates an example of a conference process screen provided by a conference service providing device and a server, according to an example embodiment.

A conference process screen 900 may display information on members each having a separate and independent icon, as illustrated in FIG. 11. In order to distinguish a talking user from members included in a conference room, an icon for an attending member may be displayed as a talking icon 901. Also, information on members who are presently attending the conference, i.e., information on attending members may be separately and independently displayed on an upper portion 902 of the conference process screen 900. The conference process screen 900 may include a duration time of the conference 903, a button for deactivating the conference 904, and a button for a speaker mode 905 in a lower portion thereof.

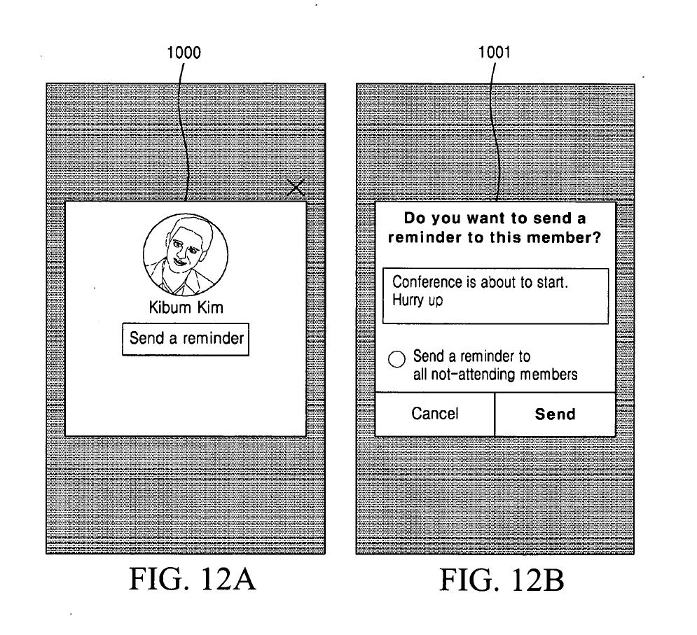

FIGS. 12A-B illustrates screens of re-transmitting an invitation message for a conference, provided by a conference service providing device and a server, according to an example embodiment.

A conference service providing device and a server may re-transmit an invitation message for a conference 1000 to one member, Kibum Kim, from among members included in a conference room. The conference service providing device and the server may provide a function of editing a message to be included in the invitation message. The conference service providing device and the server may re-transmit the invitation message for the conference after a user directly input a message as illustrated in 1001.

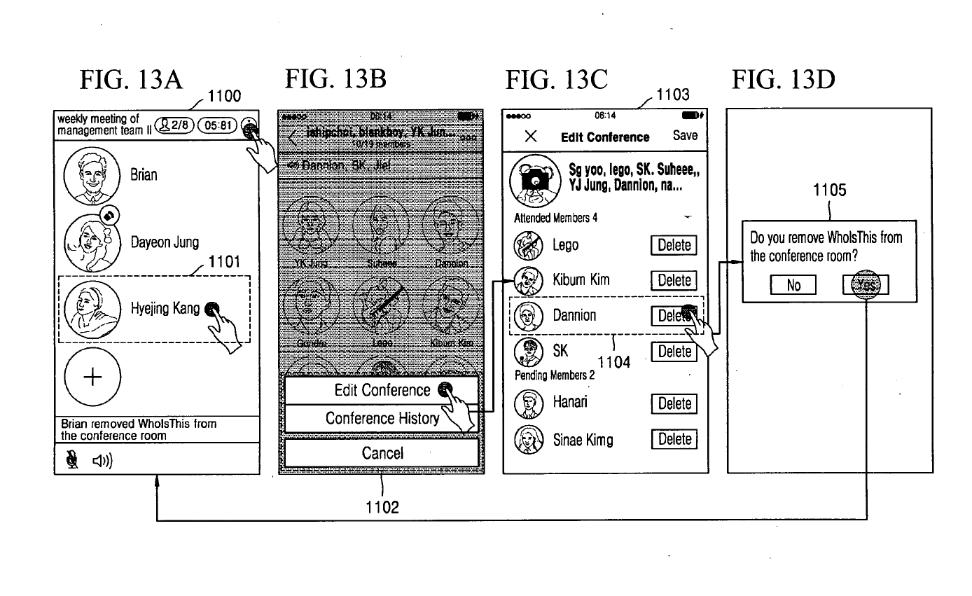

FIGS. 13A-D illustrates screens of a removal request, provided by a conference service providing device, according to an example embodiment. The conference service providing device may receive a removal command for a member selected from members included in a conference process screen 1100. The conference service providing device may display a pop-up window providing a menu item of editing the conference room, in response to an event 1101 for selecting a member. When a user selects the menu item of editing the conference room on the pop-up window, the conference service providing device may provide a screen 1103 for removing all or some of the members. The conference service providing device may display a pop-up window 1105 of removing a member, ‘Danion’, in response to an event 1104 for selecting a member. As illustrated in FIG. 11, any member included in the conference room may remove all or some of the members from the conference room.

As described above, according to one or more example embodiments, provided is a conference service shared between a plurality of users.

Also, according to one or more example embodiments, a user may concurrently process a plurality of conferences.

Also, according to one or more example embodiments, provided is a conference service generating a representative image showing information on members attending a conference at a glance.

Also, according to one or more example embodiments, provided is a conference service deleting noise irrelevant to a conference and only providing voice data related to the conference.

Example embodiments disclosed herein may comprise program code including program instructions, software components, software modules, data files, data structures, and/or the like that are implemented by one or more physical hardware devices. Examples of program code include both machine code produced by a compiler and higher level program code that is executed using an interpreter. The hardware devices may include one or more processors. The one or more processors are computer processing devices configured to carry out the program code by performing arithmetical, logical, and input/output operations. Once the program code is loaded into the one or more processors, the one or more processors may be programmed to perform the program code, thereby transforming the one or more processors into special purpose processor(s).

Alternatively, or in addition to the processors discussed above, the hardware devices may include one or more Central Processing Units (CPUs), digital signal processors (DSPs), application-specific-integrated-circuits (ASICs), SoCs, field programmable gate arrays (FPGAs), or the like. In at least some cases, the one or more CPUs, SoCs, DSPs, ASICs and FPGAs, may generally be referred to as processing circuits and/or microprocessors.

The hardware devices may also include one or more storage devices. The one or more storage devices may be tangible or non-transitory computer-readable storage media, such as random access memory (RAM), read only memory (ROM), a permanent mass storage device (such as a disk drive), and/or any other like data storage mechanism capable of storing and recording data. The one or more storage devices may be configured to store program code for one or more operating systems and/or the program code for implementing the example embodiments described herein. The program code may also be loaded from a separate computer readable storage medium into the one or more storage devices and/or the one or more processors using a drive mechanism. Such separate computer readable storage medium may include a USB flash drive, memory stick, Blu-ray/DVD/CD-ROM drive, memory card, and/or other like computer readable storage medium (not shown). The program code may be loaded into the one or more storage devices and/or the one or more processors from a remote data storage device via a network interface, rather than via a computer readable storage medium. Additionally, the program code may be loaded into the one or more storage devices and/or the one or more processors from a remote computing system that is configured to transfer and/or distribute the program code over a network. The remote computing system may transfer and/or distribute the program code via a wired interface, an air interface, and/or any other like tangible or intangible medium. The one or more processors, the one or more storage devices, and/or the program code may be specially designed and constructed for the purposes of the example embodiments, or they may be known devices that are altered and/or modified for the purposes of the example embodiments.

Example implementations shown and described herein are illustrative examples of inventive concepts and are not intended to otherwise limit the scope of inventive concepts in any way. For the sake of brevity, conventional electronics, control systems, software development and other functional aspects of the systems may not be described in detail. Furthermore, the connecting lines, or connectors shown in the various figures presented are intended to represent example functional relationships and/or physical or logical couplings between the various elements. It should be noted that many alternative or additional functional relationships, physical connections or logical connections may be present in a practical device. Moreover, no item or component is essential to the practice of the inventive concept unless the element is specifically described as “essential” or “critical”.

It should be understood that example embodiments described herein should be considered in a descriptive sense only and not for purposes of limitation. Descriptions of features or aspects within each example embodiment should typically be considered as available for other similar features or aspects in other example embodiments.

While one or more example embodiments have been described with reference to the figures, it will be understood by those of ordinary skill in the art that various changes in form and details may be made therein without departing from the spirit and scope as defined by the following claims.

What is claimed is:

1. A method of providing a conference service, the method comprising:
receiving, by a processor, a request from a first terminal for creating a conference with a second terminal and a third terminal as members of the conference;
in response to the request for creating the conference, creating, by the processor, the conference that has the first to third terminals as members;
receiving, by the processor, a voice file including one or more pieces of sound data with a volume equal to or greater than a threshold volume, and information on an at least one attending member, from at least one of the first terminal, the second terminal and the third terminal, the at least one attending member being from among the first terminal, the second terminal and the third terminal;
generating, by the processor, conference data by merging the received voice file and the information on the at least one attending member; and
providing, by the processor, the conference data to the first terminal, the second terminal and the third terminal,
wherein the attending member is a member of the conference room who owns a terminal via which sound is input with a volume equal to or greater than the threshold volume.

2. The method of claim 1, wherein the creating the conference comprises:
in response to the request for creating the conference room, generating a conference status screen of the conference;
providing the conference status screen to the first terminal;
receiving a final request for creating a conference room that has second and third terminals as members, from the first terminal; and
in response to the final request for creating the conference, creating the conference that has the first to third terminals as the members,
wherein the conference status screen displays the status of the conference, and includes information on the members included in the conference or information on the members attending the conference.

3. The method of claim 1, wherein the conference data comprises at least one of:
data selected from information on at least one the attending member included in a conference process screen of the conference,
profile photos of the members,
status information on the members,
time information on when each of the members attends and leave the conference,
the total number of members in the conference,
duration time of the conference, and
status information on the conference.

4. The method of claim 1, wherein the creating the conference comprises:
transmitting an invitation message including a link to the conference, to the second terminal and the third terminal; and
in response to an event for selecting the link, allowing at least one of the second and third terminals to attend the conference,
wherein the status of the attending member in the conference is set as attending.

5. The method of claim 1, wherein the creating the conference comprises:
transmitting an invitation message including a link to the conference, to the second terminal and the third terminal;
in response to an input, from at least one of the second terminal and third terminal for selecting the link, moving at least one of the second terminal and third terminal to a conference status screen of the conference;
receiving an input for attending the conference on the conference status screen, from at least one of the second terminal and the third terminal; and
in response to the input for attending the conference, allowing the at least one of the second terminal and third terminal to attend the conference,
wherein the conference status screen displays the status of the conference, and includes information on the members included in the conference or information on the members attending the conference, and
the status of the attending terminal in the conference is set as attending.

6. The method of claim 1, wherein the conference data includes at least one of,
a representative image, the representative image being divided into regions corresponding to a number of the members included the conference, and
profile photos of the members included in the conference.

7. A non-transitory computer-readable recording medium storing computer-readable instructions, which when executed by a processor, causes the processor to perform the method of claim 1.

8. A method of providing a conference service, the method comprising:
receiving, at a processor, a request from a first terminal for creating a first conference having a second terminal and a third terminal as members;
creating, by the processor, the first conference in response to the first request;
receiving, by the processor, at least one of,
a first voice file including sound data with a volume equal to or greater than a threshold volume from the first terminal when the first conference is activated,
a second voice file that includes one or more sound data with a corresponding volume equal to or greater than the threshold volume and
information on an attending member from at least one of the second terminal and the third terminal;
outputting, by the processor, the second voice file,
displaying, by the processor, a first conference process screen by setting at least one or more of the members as attending members based on the information on the attending member; and
transmitting, by the processor, the first voice file to the second terminal and the third terminal,
wherein the status of the first conference is determined upon a request from one of the first terminal, the second terminal and the third terminal, and the attending member is one of the first terminal, the second terminal and the third terminal via which sound is input with a volume equal to or greater than the threshold volume.

9. The method of claim 8, wherein the second voice file includes at least one of,
first sound data received from the second terminal and having a volume equal to or greater than the threshold volume, and
second sound data received from the third terminal and having a volume equal to or greater than the threshold volume.

10. The method of claim 8, further comprising:
receiving a signal for requesting to deactivate the first conference from the first terminal; and
in response to the received signal, converting the status of the first conference from active to being deactivated,
wherein, when the status of the first conference is deactivated, the first conference process screen is not updated and does not transmit input sound to the second terminal and the third terminal.

11. The method of claim 8, further comprising:
receiving, by the processor, a request from the first terminal for creating a second conference having a fourth terminal and a fifth terminal as members; and
in response to the request for creating the second conference, creating, by the processor, the second conference.

12. The method of claim 11, further comprising:
receiving, by using a communication unit, an invitation message for a third conference from a terminal creating the third conference room;
in response to the invitation message for the third conference, accessing the third conference;
receiving a conference status screen of the second conference and displaying the conference status screen of the second conference in order to identify information on members included in the third conference and information on attending members;
receiving an input of a signal for attending the third conference; and
in response to the signal for attending the third conference, attending the third conference.

13. A non-transitory computer-readable recording storing computer-readable instructions, which when executed by a processor, cause the processor to perform the method of claim 8.

14. A conference service providing server comprising:
a memory having computer-readable instructions stored therein; and
a processor configured to execute the computer-readable instructions to,
receive a request from a first terminal for creating a conference having a second terminal and a third terminal as members;
creating the conference having the first terminal, the second terminal and the third terminal as the members in response to the received request;
receive a voice file that includes,
one or more sound data with a volume equal to or greater than a threshold volume and received from at least one attending member, the at least one attending member being from among the first terminal, the second terminal and the third terminal, and
information on the attending member;
generate conference data by merging the received voice file and the information on the at least one attending member; and
provide the conference data to the terminals of the members,
wherein the attending member is a member of the conference room and owns a terminal inputting sound with a volume equal to or greater than the threshold volume.

15. The conference service providing server of claim 14, wherein, in response to the request for creating the conference, the processor is configured to, generate a conference status screen of the conference to provide the conference status screen to the first terminal,
receive a final request from the first terminal for creating the conference room having the second terminal and the third terminal as members,
create the conference room having the first terminal, the second terminal and the third terminal as members in response to the final request, and
display the status of the conference and includes information on the members included in the conference or information on the members attending the conference.

16. The conference service providing server of claim 14, wherein the conference data includes at least one of,
information on attending members included in a conference process screen of the conference,
profile photos of the members,
status information on the members, time information on when the members attend and leave the conference,
the total number of members of the conference,
time duration of the conference, and
status information of the conference.

17. The conference service providing server of claim 14, wherein the processor is configured to,
transmit to the second terminal and the third terminal an invitation message including a link to the conference, and
in response to an event for selecting the link, allow at least one of the second terminal and third terminal to attend the conference, the status of the at least one of the second terminal and the third terminal attending the conference is set as attending.

18. The conference service providing server of claim 14, wherein the processor is configured to,
transmit to the second terminal and the third terminal an invitation message including a link to the conference,
in response to an input, received from at least one of the second terminal and the third terminal, for selecting the link, move at least one of the second terminal and the third terminal to a conference status screen of the conference,
receive from the at least one of the second terminal and the third terminal, an input on the conference status screen, for attending the conference,
in response to the input on the conference status screen, allow at least one of the second terminal and third terminal to attend the conference,
display the status of the conference including information on the members included in the conference or information on the members attending the conference, and
set the status of the members attending the conference to attending.

19. The conference service providing server of claim 14, wherein
the conference data includes a representative image, the representative image being divided into regions of the number of members included in the conference room, and
profile photos of a plurality of the members included in the conference.
